(19) United States
(12) Patent Application Publication
(10) Pub. No.: US 2023/0193095 A1
(43) Pub. Date: Jun. 22, 2023

(54) PRESSURE SENSITIVE ADHESIVE

(71) Applicant: Saint-Gobain Performance Plastics Corporation, Solon, OH (US)

(72) Inventors: Dahlia Amato, Malvern, PA (US); Gerald A. Elliott, Bennington, VT (US); Jeffrey H. Peet, Southborough, MA (US); Rachel Brown, Shrewsbury, MA (US); Fei Wang, Winchester, MA (US)

(21) Appl. No.: 18/066,442

(22) Filed: Dec. 15, 2022

Related U.S. Application Data
(60) Provisional application No. 63/265,541, filed on Dec. 16, 2021.

(51) Int. Cl. C09J 183/04

(52) U.S. Cl. CPC C09J 183/04

(57) ABSTRACT

The present disclosure relates to a pressure sensitive adhesive may include a silicone based pressure sensitive adhesive component, and an iron oxide filler mixture. The content of the iron oxide filler mixture may be at least about 0.5 wt. % and not greater than about 10.0 wt. % for a total weight of the pressure sensitive adhesive. The pressure sensitive adhesive may have a peel adhesion of at least about 600 g/in when measured at 25° C., and the pressure sensitive adhesive may further have a UL 94 rating of VTM-0, a UL 94 rating of V-0, or a UL 94 rating of both VTM-0 and V-0 when attached to a backing material.

### CROSS-REFERENCE TO RELATED APPLICATION(S)

This Application claims priority under 35 U.S.C. § 119(e) to U.S. Provisional Patent Application No. 63/265,541, entitled “PRESSURE SENSITIVE ADHESIVE,” by Dahlia AMATO et al., filed Dec. 16, 2021, which is assigned to the current assignee hereof and is incorporated herein by reference in its entirety.

### FIELD OF THE DISCLOSURE

The present disclosure relates to a pressure sensitive adhesive, in particular, a thermally stable silicone based pressure sensitive adhesive.

### BACKGROUND

Pressure sensitive adhesives are used in various applications where thermal stability is needed. For example, pressure sensitive adhesives with thermal stability may be used in various electric vehicle applications or thermal spray applications. Accordingly, pressure sensitive adhesives with fire retardant capabilities are desired.

### SUMMARY

According to a first aspect, a pressure sensitive adhesive may include a silicone based pressure sensitive adhesive component, and an iron oxide filler mixture component. The content of the iron oxide filler mixture may be at least about 0.5 wt. % and not greater than about 10.0 wt. % for a total weight of the pressure sensitive adhesive. The pressure sensitive adhesive may have a peel adhesion of at least about 600 g/in when measured at 25° C., and the pressure sensitive adhesive may further have a UL 94 rating of VTM-0, a UL 94 rating of V-0 or a UL 94 rating of both VTM-0 and V-0 when attached to a backing material.

According to another aspect, a tape may include a backing layer and a layer of pressure sensitive adhesive. The pressure sensitive adhesive may include a silicone based pressure sensitive adhesive component, and an iron oxide filler mixture component. The content of the iron oxide filler mixture may be at least about 0.5 wt. % and not greater than about 10.0 wt. % for a total weight of the pressure sensitive adhesive. The pressure sensitive adhesive may have a peel adhesion of at least about 600 g/in when measured at 25° C., and the pressure sensitive adhesive may further have a UL 94 rating of VTM-0, a UL 94 rating of V-0, or a UL 94 rating of both VTM-0 and V-0 when attached to a backing material.

A method of forming a pressure sensitive adhesive may include providing a forming mixture of a silicone based pressure sensitive adhesive precursor component and an iron oxide filler precursor mixture component, and forming the mixture into a pressure sensitive adhesive. The pressure sensitive adhesive may include a silicone based pressure sensitive adhesive component, and an iron oxide filler mixture component. The content of the iron oxide filler mixture may be at least about 0.5 wt. % and not greater than about 10.0 wt. % for a total weight of the pressure sensitive adhesive. The pressure sensitive adhesive may have a peel adhesion of at least about 600 g/in when measured at 25° C., and the pressure sensitive adhesive may further have a UL 94 rating of VTM-0, a UL 94 rating of V-0 or a UL 94 rating of both VTM-0 and V-0 when attached to a backing material.

### BRIEF DESCRIPTION OF THE DRAWINGS

Embodiments are illustrated by way of example and are not limited to the accompanying figures.

FIG. 1 includes a diagram showing a pressure sensitive adhesive forming method according to embodiments described herein;

FIG. 2 includes an illustration showing the configuration of a layer of pressure sensitive adhesive formed according to embodiments described herein;

FIG. 3 includes a diagram showing a tape forming method according to embodiments described herein; and

FIG. 4 includes an illustration showing the configuration of a tape formed according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a pressure sensitive adhesive that may include a silicone based pressure sensitive adhesive component, and an iron oxide filler mixture component within the silicone based pressure sensitive adhesive component.

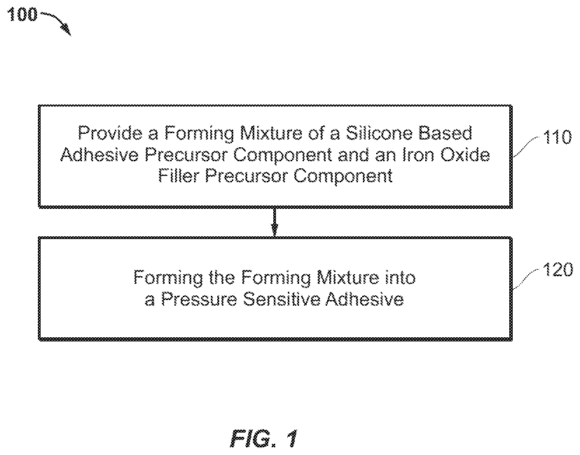

Referring first to a method of forming a dielectric substrate, FIG. 1 includes a diagram showing a forming method 100 for forming a pressure sensitive adhesive according to embodiments described herein. According to particular embodiments, the forming method 100 may include a first step 110 of providing a forming mixture of a silicone based pressure sensitive adhesive precursor component and an iron oxide filler precursor mixture component, and a second step 120 of forming the mixture into a pressure sensitive adhesive.

According to a particular embodiment, the iron oxide filler precursor mixture component may include black iron oxide. According to other embodiments, the iron oxide filler precursor mixture component may include silicone resin. According to yet other embodiments, the iron oxide filler precursor mixture component may include an organic solvent. According to yet other embodiments, the iron oxide filler precursor mixture component may include a surfactant. According to other embodiments, the iron oxide filler precursor mixture component may include any combination of black iron oxide, silicone resin/fluid, with or without organic solvent and a surfactant.

According to a particular embodiment, the iron oxide filler precursor mixture component may consist of black iron oxide. According to other embodiments, the iron oxide filler precursor mixture component may consist of silicone resin. According to yet other embodiments, the iron oxide filler precursor mixture component may consist of an organic solvent. According to yet other embodiments, the iron oxide filler precursor mixture component may consist of a surfactant. According to other embodiments, the iron oxide filler precursor mixture component may consist of any combination of black iron oxide, silicone resin/fluid, with or without organic solvent and a surfactant.

According to yet other embodiments, the forming mixture may include a particular content of the iron oxide filler precursor mixture component. For example, the iron oxide filler precursor mixture component content may be at least about 0.6 wt. % for a total weight of the forming mixture, such as, at least about 0.7 wt. % or at least about 0.8 wt. % or at least about 0.9 wt. % or at least about 1.0 wt. % or at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the iron oxide filler precursor mixture component content may be not greater than about 10.0 wt. % for a total weight of the forming mixture, such as, not greater than about 9.0 wt. % or not greater than about 8 wt. % or not greater than about 7 wt. % or not greater than about 6 wt. % not greater than about 5.8 wt. % or not greater than about 5.7 wt. % or not greater than about 5.6 wt. % or not greater than about 5.5 wt. % or not greater than about 5.4 wt. % or not greater than about 5.3 wt. % or not greater than about 5.2 wt. % or even not greater than about 5.1 wt. %. It will be appreciated that the iron oxide filler precursor mixture component content may be any value between, and including, any of the minimum and maximum values noted above. It will be further appreciated that the iron oxide filler precursor mixture component content may be within a range between, and including, any of the minimum and maximum values noted above.

According to still other embodiments, the silicone based pressure sensitive adhesive precursor component may include a methyl silicone adhesive. According to yet other embodiments, the silicone based pressure sensitive adhesive precursor component may include a phenyl silicone adhesive. According to still other embodiments, the silicone based pressure sensitive adhesive precursor component may include a vinyl silicone adhesive. According to yet other embodiments, the silicone based pressure sensitive adhesive precursor component may include any combination of a methyl silicone adhesive, a phenyl silicone adhesive, and a vinyl silicone adhesive.

According to still other embodiments, the silicone based pressure sensitive adhesive precursor component may consist of a methyl silicone adhesive. According to yet other embodiments, the silicone based pressure sensitive adhesive precursor component may consist of a phenyl silicone adhesive. According to still other embodiments, the silicone based pressure sensitive adhesive precursor component may consist of a vinyl silicone adhesive. According to yet other embodiments, the silicone based pressure sensitive adhesive precursor component may consist of any combination of a methyl silicone adhesive, a phenyl silicone adhesive, and a vinyl silicone adhesive.

According to yet other embodiments, the forming mixture may include a particular content of the silicone based pressure sensitive adhesive precursor component. For example, the silicone based pressure sensitive adhesive precursor component content may be at least about 45 wt. % for a total weight of the forming mixture, such as, at least about 47 wt. % or at least about 50 wt. % or at least about 52 wt. % or at least about 55 wt. % or at least about 57 wt. % or at least about 60 wt. % or at least about 62 wt. % or at least about 65 wt. % or at least about 67 wt. % or at least about 70 wt. % or at least about 72 wt. % or at least about 75 wt. % or at least about 77 wt. % or even at least about 80 wt. %. According to still other embodiments, the silicone based pressure sensitive adhesive precursor component content may be not greater than about 98 wt. % for a total weight of the forming mixture, such as, not greater than about 95 wt. % or not greater than about 92 wt. % or not greater than about 90 wt. % or not greater than about 87 wt. % or not greater than about 85 wt. % or even not greater than about 82 wt. %. It will be appreciated that the silicone based pressure sensitive adhesive precursor component content may be any value between, and including, any of the minimum and maximum values noted above. It will be further appreciated that the silicone based pressure sensitive adhesive precursor component content may be within a range between, and including, any of the minimum and maximum values noted above.

According to still other embodiments, the forming mixture may further include a catalyst. According to yet other embodiments, the catalyst may include peroxide. According to still other embodiments, the catalyst may include platinum. According to yet other embodiments, the catalyst may consist of peroxide. According to still other embodiments, the catalyst may consist of platinum.

According to still other embodiments, the forming mixture may include a silicone resin.

According to yet other embodiments, the forming mixture may include an organic solvent. According to still other embodiments, the organic solvent may include toluene. According to still other embodiments, the organic solve may include xylene. According to yet other embodiments, the organic solvent may include ethyl acetate. According to still other embodiments, the organic solvent may consist of toluene. According to still other embodiments, the organic solve may consist of xylene. According to yet other embodiments, the organic solvent may consist of ethyl acetate.

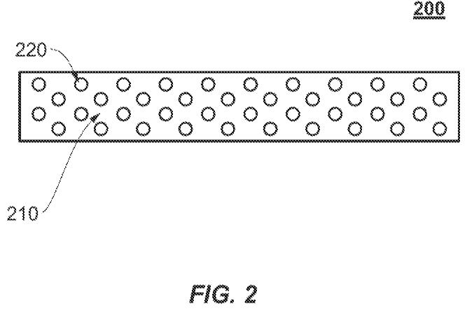

Referring now to embodiments of the pressure sensitive adhesive formed according to forming method 100, FIG. 2 includes diagram of a layer of pressure sensitive adhesive 200. As shown in FIG. 2, the pressure sensitive adhesive 200 may include a silicone based pressure sensitive adhesive component 210 and an iron oxide filler mixture component 220.

According to a particular embodiment, the iron oxide filler mixture component 220 may include black iron oxide. According to other embodiments, the iron oxide filler mixture component 220 may include silicone resin. According to yet other embodiments, the iron oxide filler mixture component 220 may include an organic solvent. According to other embodiments, the iron oxide filler mixture component 220 may include any combination of black iron oxide, silicone resin/fluid, with or without organic solvent.

According to a particular embodiment, the iron oxide filler mixture component 220 may consist of black iron oxide. According to other embodiments, the iron oxide filler mixture component 220 may consist of silicone resin. According to yet other embodiments, the iron oxide filler mixture component 220 may consist of an organic solvent. According to other embodiments, the iron oxide filler mixture component 220 may consist of any combination of black iron oxide, silicone resin/fluid, with or without organic solvent.

According to yet other embodiments, the pressure sensitive adhesive 200 may include a particular content of the iron oxide filler mixture component 220. For example, the iron oxide filler mixture component 220 content may be at least about 0.6 wt. % for a total weight of the pressure sensitive adhesive 200, such as, at least about 0.7 wt. % or at least about 0.8 wt. % or at least about 0.9 wt. % or at least about 1.0 wt. % or at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the iron oxide filler mixture component 220 content may be not greater than about 10 wt. % for a total weight of the pressure sensitive adhesive 200, such as, not greater than about 9.0 wt. % or not greater than about 8 wt. % or not greater than about 7 wt. % or not greater than about 6 wt. % not greater than about 5.8 wt. % or not greater than about 5.7 wt. % or not greater than about 5.6 wt. % or not greater than about 5.5 wt. % or not greater than about 5.4 wt. % or not greater than about 5.3 wt. % or not greater than about 5.2 wt. % or even not greater than about 5.1 wt. %. It will be appreciated that the iron oxide filler mixture component 220 content may be any value between, and including, any of the minimum and maximum values noted above. It will be further appreciated that the iron oxide filler mixture component 220 content may be within a range between, and including, any of the minimum and maximum values noted above.

According to still other embodiments, the silicone based pressure sensitive adhesive component 210 may include a methyl silicone adhesive. According to yet other embodiments, the silicone based pressure sensitive adhesive component 210 may include a phenyl silicone adhesive. According to still other embodiments, the silicone based pressure sensitive adhesive component 210 may include a vinyl silicone adhesive. According to yet other embodiments, the silicone based pressure sensitive adhesive component 210 may include any combination of a methyl silicone adhesive, a phenyl silicone adhesive, and a vinyl silicone adhesive.

According to still other embodiments, the silicone based pressure sensitive adhesive component 210 may consist of a methyl silicone adhesive. According to yet other embodiments, the silicone based pressure sensitive adhesive component 210 may consist of a phenyl silicone adhesive. According to still other embodiments, the silicone based pressure sensitive adhesive component 210 may consist of a vinyl silicone adhesive. According to yet other embodiments, the silicone based pressure sensitive adhesive component 210 may consist of any combination of a methyl silicone adhesive, a phenyl silicone adhesive, and a vinyl silicone adhesive.

According to yet other embodiments, the pressure sensitive adhesive 200 may include a particular content of the silicone based pressure sensitive adhesive component 210. For example, the silicone based pressure sensitive adhesive component 210 content may be at least about 45 wt. % for a total weight of the pressure sensitive adhesive 200, such as, at least about 47 wt. % or at least about 50 wt. % or at least about 52 wt. % or at least about 55 wt. % or at least about 57 wt. % or at least about 60 wt. % or at least about 62 wt. % or at least about 65 wt. % or at least about 67 wt. % or at least about 70 wt. % or at least about 72 wt. % or at least about 75 wt. % or at least about 77 wt. % or even at least about 80 wt. %. According to still other embodiments, the silicone based pressure sensitive adhesive component 210 content may be not greater than about 98 wt. % for a total weight of the pressure sensitive adhesive 200, such as, not greater than about 95 wt. % or not greater than about 92 wt. % or not greater than about 90 wt. % or not greater than about 87 wt. % or not greater than about 85 wt. % or even not greater than about 82 wt. %. It will be appreciated that the silicone based pressure sensitive adhesive component 210 content may be any value between, and including, any of the minimum and maximum values noted above. It will be further appreciated that the silicone based pressure sensitive adhesive component 210 content may be within a range between, and including, any of the minimum and maximum values noted above.

According to still other embodiments, the pressure sensitive adhesive 200 may further include a catalyst. According to yet other embodiments, the catalyst may include peroxide. According to still other embodiments, the catalyst may include platinum. According to yet other embodiments, the catalyst may consist of peroxide. According to still other embodiments, the catalyst may consist of platinum.

According to still other embodiments, the pressure sensitive adhesive 200 may include a silicone resin.

According to yet other embodiments, the pressure sensitive adhesive 200 may include an organic solvent. According to still other embodiments, the organic solvent may include toluene. According to still other embodiments, the organic solve may include xylene. According to yet other embodiments, the organic solvent may include ethyl acetate. According to still other embodiments, the organic solvent may consist of toluene. According to still other embodiments, the organic solve may consist of xylene. According to yet other embodiments, the organic solvent may consist of ethyl acetate.

According to still other embodiments, the pressure sensitive adhesive 200 may have a particular peel adhesion as measured at 25° C. according to ASTM D3330. For example, the pressure sensitive adhesive 200 may have a peel adhesion of at least about 610 g/in, such as, at least about 620 g/in or at least about 630 g/in or at least about 640 g/in or at least about 650 g/in or at least about 660 g/in or at least about 670 g/in or at least about 680 g/in or at least about 690 g/in or at least about 700 g/in or at least about 710 g/in or even at least about 720 g/in. According to still other embodiments, the pressure sensitive adhesive 200 may have a peel adhesion of not greater than about 760 g/in, such as, not greater than about 750 g/in or not greater than about 740 g/in. It will be appreciated that the silicone based pressure sensitive adhesive component 210 peel adhesion at 25° C. may be any value between, and including, any of the minimum and maximum values noted above. It will be further appreciated that the silicone based pressure sensitive adhesive component 210 peel adhesion at 25° C. may be within a range between, and including, any of the minimum and maximum values noted above.

According to still other embodiments, the pressure sensitive adhesive 200 may have a particular peel adhesion as measured at 100° C. according to ASTM D3330 (modified such that the heated chamber attached with the thermocouple during the peel test such that the tape and the stainless steel substrates are heated at 100° C. for a 1-minute dwell prior to peeling the tape from the stainless steel). For example, the pressure sensitive adhesive 200 may have a peel adhesion of at least about 280 g/in, such as, at least about 290 g/in or at least about 300 g/in or at least about 310 g/in or at least about 320 g/in or at least about 330 g/in or at least about 340 g/in or at least about 350 g/in or at least about 360 g/in or at least about 370 g/in or at least about 380 g/in or even at least about 390 g/in. According to still other embodiments, the pressure sensitive adhesive 200 may have a peel adhesion of not greater than about 430 g/in, such as, not greater than about 420 g/in or not greater than about 410 g/in. It will be appreciated that the silicone based pressure sensitive adhesive component 210 peel adhesion at 100° C. may be any value between, and including, any of the minimum and maximum values noted above. It will be further appreciated that the silicone based pressure sensitive adhesive component 210 peel adhesion at 100° C. may be within a range between, and including, any of the minimum and maximum values noted above.

According to still other embodiments, the pressure sensitive adhesive 200 may have a particular peel adhesion as measured at 250° C. according to ASTM D3330 (modified such that the heated chamber attached with the thermocouple during the peel test such that the tape and the stainless steel substrates are heated at 250° C. for a 1-minute dwell prior to peeling the tape from the stainless steel). For example, the pressure sensitive adhesive 200 may have a peel adhesion of at least about 50 g/in, such as, at least about 55 g/in or at least about 60 g/in or at least about 65 g/in or at least about 70 g/in or at least about 75 g/in or at least about 80 g/in or even at least about 85 g/in. According to still other embodiments, the pressure sensitive adhesive 200 may have a peel adhesion of not greater than about 100 g/in, such as, not greater than about 95 g/in or not greater than about 90 g/in. It will be appreciated that the silicone based pressure sensitive adhesive component 210 peel adhesion at 250° C. may be any value between, and including, any of the minimum and maximum values noted above. It will be further appreciated that the silicone based pressure sensitive adhesive component 210 peel adhesion at 250° C. may be within a range between, and including, any of the minimum and maximum values noted above.

According to still other embodiments, the pressure sensitive adhesive 200 may have a particular tack as measured using a Texture Analyzer-303C fixture with a 5 mm probe made out of stainless steel, where each sample (5×1 inch, with four replicates) is measured with 2 minutes of contact time, a 0.5 mm/s approach speed, and a 10 mm/s debonding speed. For example, the pressure sensitive adhesive 200 may have a tack of at least about 4.2 N, such as, at least about 4.3 N or at least about 4.4 N or at least about 4.5 N or at least about 4.6 N or at least about 4.7 N or at least about 4.8 N or even at least about 4.9 N. According to still other embodiments, the pressure sensitive adhesive 200 may have a tack of not greater than about 6 N, such as, not greater than about 5.8 N or not greater than about 5.6 N. It will be appreciated that the silicone4 based pressure sensitive adhesive component 210 tack may be any value between, and including, any of the minimum and maximum values noted above. It will be further appreciated that the silicone based pressure sensitive adhesive component 210 tack may be within a range between, and including, any of the minimum and maximum values noted above.

According to still other embodiments, the pressure sensitive adhesive 200 may have a particular Shear Adhesion Failure Temperature (SAFT) as measured according to ASTM PSTC-17. For example, the pressure sensitive adhesive 200 may have a SAFT of at least about 90° C., such as, at least about 100° C. or at least about 110° C. or at least about 120° C. or at least about 130° C. or at least about 140° C. or at least about 150° C. or even at least about 160° C. According to still other embodiments, the pressure sensitive adhesive 200 may have a tack of not greater than about 200° C., such as, not greater than about 190° C. or not greater than about 180 ° C. It will be appreciated that the silicone based pressure sensitive adhesive component 210 SAFT may be any value between, and including, any of the minimum and maximum values noted above. It will be further appreciated that the silicone based pressure sensitive adhesive component 210 SAFT may be within a range between, and including, any of the minimum and maximum values noted above.

According to yet other embodiments, the pressure sensitive adhesive 200 may have a UL 94 rating of VTM-0 when attached to a backing material. According to still other embodiments, the pressure sensitive adhesive 200 may have a UL 94 rating of V-0. According to still other embodiments, the pressure sensitive adhesive 200 may have a UL 94 rating of both VTM-0 and V-0. It will be appreciated that the appropriate UL 94 rating may depended on the attached backing material, if any, that is used when testing occurs.

Turning now to embodiments of tape that may include a pressure sensitive adhesive as described herein. Such additional embodiments described herein are generally directed to a tape that may include a backing layer and a layer of pressure sensitive adhesive overlying the backing layer. According to certain embodiments, the pressure sensitive adhesive that may include a silicone based pressure sensitive adhesive component, and an iron oxide filler mixture within the silicone based pressure sensitive adhesive component.

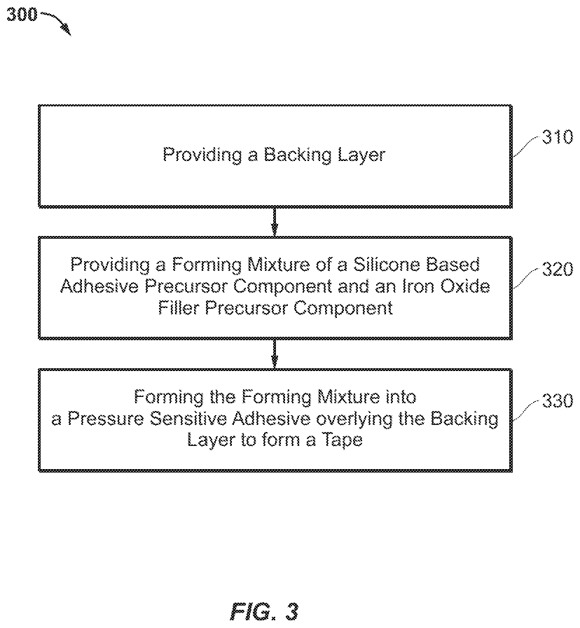

Referring next to a method of forming a tape, FIG. 3 includes a diagram showing a forming method 300 for forming a tape according to embodiments described herein. According to particular embodiments, the forming method 300 may include a first step 310 of providing a backing layer, a second step 320 of providing a forming mixture of a silicone based pressure sensitive adhesive precursor component and an iron oxide filler precursor mixture component, and a third step 330 of forming the mixture into a layer of pressure sensitive adhesive overlying the backing layer to form the tape.

According to still other embodiments, the backing layer may include cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof. Cloth backings can be untreated, saturated, pre-sized, backsized, porous, or sealed, and they may be woven or stitch bonded. The cloth backings may include fibers or yarns of cotton, polyester, rayon, silk, nylon or blends thereof. The cloth backings can be provided as laminates with different backing materials described herein. Paper backings also can be saturated, barrier coated, pre-sized, backsized, untreated, or fiber-reinforced. The paper backings also can be provided as laminates with a different type of backing material. Nonwoven backings include scrims and laminates to different backing materials mentioned herein. The nonwovens may be formed of cellulosic fibers, synthetic fibers or blends thereof. Polymeric backings include polyolefin or polyester films. The polymeric backings can be provided as blown film, or as laminates of different types of polymeric materials, or laminates of polymeric films with a non-polymeric type of backing material. The backing can also be a stem web used alone or incorporating a nonwoven, or as a laminate with a different type of backing. The loop fabric backing can be brushed nylon, brushed polyester, polyester stitched loop, and loop material laminated to a different type of backing material. The foam backing may be a natural sponge material or polyurethane foam and the like. The foam backing also can be laminated to a different type of backing material. The mesh backings can be made of polymeric or metal open-weave scrims. According to certain embodiments, the backing may include mica.

According to a particular embodiment, the iron oxide filler precursor mixture component may include black iron oxide. According to other embodiments, the iron oxide filler precursor mixture component may include silicone resin. According to yet other embodiments, the iron oxide filler precursor mixture component may include an organic solvent. According to other embodiments, the iron oxide filler precursor mixture component may include any combination of black iron oxide, silicone resin/fluid, with or without organic solvent.

According to a particular embodiment, the iron oxide filler precursor mixture component may consist of black iron oxide. According to other embodiments, the iron oxide filler precursor mixture component may consist of silicone resin. According to yet other embodiments, the iron oxide filler precursor mixture component may consist of an organic solvent. According to other embodiments, the iron oxide filler precursor mixture component may consist of any combination of black iron oxide, silicone resin/fluid, with or without organic solvent.

According to yet other embodiments, the forming mixture may include a particular content of the iron oxide filler precursor mixture component. For example, the iron oxide filler precursor mixture component content may be at least about 0.6 wt. % for a total weight of the forming mixture, such as, at least about 0.7 wt. % or at least about 0.8 wt. % or at least about 0.9 wt. % or at least about 1.0 wt. % or at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the iron oxide filler precursor mixture component content may be not greater than about 10.0 wt. % for a total weight of the forming mixture, such as, not greater than about 9.0 wt. % or not greater than about 8 wt. % or not greater than about 7 wt. % or not greater than about 6 wt. % not greater than about 5.8 wt. % or not greater than about 5.7 wt. % or not greater than about 5.6 wt. % or not greater than about 5.5 wt. % or not greater than about 5.4 wt. % or not greater than about 5.3 wt. % or not greater than about 5.2 wt. % or even not greater than about 5.1 wt. %. It will be appreciated that the iron oxide filler precursor mixture component content may be any value between, and including, any of the minimum and maximum values noted above. It will be further appreciated that the iron oxide filler precursor mixture component content may be within a range between, and including, any of the minimum and maximum values noted above.

According to still other embodiments, the silicone based pressure sensitive adhesive precursor component may include a methyl silicone adhesive. According to yet other embodiments, the silicone based pressure sensitive adhesive precursor component may include a phenyl silicone adhesive. According to still other embodiments, the silicone based pressure sensitive adhesive precursor component may include a vinyl silicone adhesive. According to yet other embodiments, the silicone based pressure sensitive adhesive precursor component may include any combination of a methyl silicone adhesive, a phenyl silicone adhesive, and a vinyl silicone adhesive.

According to still other embodiments, the silicone based pressure sensitive adhesive precursor component may consist of a methyl silicone adhesive. According to yet other embodiments, the silicone based pressure sensitive adhesive precursor component may consist of a phenyl silicone adhesive. According to still other embodiments, the silicone based pressure sensitive adhesive precursor component may consist of a vinyl silicone adhesive. According to yet other embodiments, the silicone based pressure sensitive adhesive precursor component may consist of any combination of a methyl silicone adhesive, a phenyl silicone adhesive, and a vinyl silicone adhesive.

According to yet other embodiments, the forming mixture may include a particular content of the silicone based pressure sensitive adhesive precursor component. For example, the silicone based pressure sensitive adhesive precursor component content may be at least about 45 wt. % for a total weight of the forming mixture, such as, at least about 47 wt. % or at least about 50 wt. % or at least about 52 wt. % or at least about 55 wt. % or at least about 57 wt. % or at least about 60 wt. % or at least about 62 wt. % or at least about 65 wt. % or at least about 67 wt. % or at least about 70 wt. % or at least about 72 wt. % or at least about 75 wt. % or at least about 77 wt. % or even at least about 80 wt. %. According to still other embodiments, the silicone based pressure sensitive adhesive precursor component content may be not greater than about 98 wt. % for a total weight of the forming mixture, such as, not greater than about 95 wt. % or not greater than about 92 wt. % or not greater than about 90 wt. % or not greater than about 87 wt. % or not greater than about 85 wt. % or even not greater than about 82 wt. %. It will be appreciated that the silicone based pressure sensitive adhesive precursor component content may be any value between, and including, any of the minimum and maximum values noted above. It will be further appreciated that the silicone based pressure sensitive adhesive precursor component content may be within a range between, and including, any of the minimum and maximum values noted above.

According to still other embodiments, the forming mixture may further include a catalyst. According to yet other embodiments, the catalyst may include peroxide. According to still other embodiments, the catalyst may include platinum. According to yet other embodiments, the catalyst may consist of peroxide. According to still other embodiments, the catalyst may consist of platinum.

According to still other embodiments, the forming mixture may include a silicone resin.

According to yet other embodiments, the forming mixture may include an organic solvent. According to still other embodiments, the organic solvent may include toluene. According to still other embodiments, the organic solve may include xylene. According to yet other embodiments, the organic solvent may include ethyl acetate. According to still other embodiments, the organic solvent may consist of toluene. According to still other embodiments, the organic solve may consist of xylene. According to yet other embodiments, the organic solvent may consist of ethyl acetate.

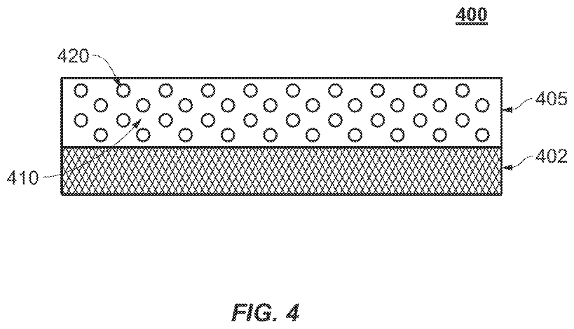

Referring now to embodiments of the tape formed according to forming method 300, FIG. 4 includes diagram of a tape 400. As shown in FIG. 4, the tape 400 may include a backing layer 402, and a layer of pressure sensitive adhesive 405 overlying a surface of the backing layer 402. According to certain embodiments, the sensitive adhesive 405 may include a silicone based pressure sensitive adhesive component 410 and an iron oxide filler mixture component 420.

According to still other embodiments, the backing layer 402 may include cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof. Cloth backings can be untreated, saturated, pre-sized, backsized, porous, or sealed, and they may be woven or stitch bonded. The cloth backings may include fibers or yarns of cotton, polyester, rayon, silk, nylon or blends thereof. The cloth backings can be provided as laminates with different backing materials described herein. Paper backings also can be saturated, barrier coated, pre-sized, backsized, untreated, or fiber-reinforced. The paper backings also can be provided as laminates with a different type of backing material. Nonwoven backings include scrims and laminates to different backing materials mentioned herein. The nonwovens may be formed of cellulosic fibers, synthetic fibers or blends thereof. Polymeric backings include polyolefin or polyester films. The polymeric backings can be provided as blown film, or as laminates of different types of polymeric materials, or laminates of polymeric films with a non-polymeric type of backing material. The backing can also be a stem web used alone or incorporating a nonwoven, or as a laminate with a different type of backing. The loop fabric backing can be brushed nylon, brushed polyester, polyester stitched loop, and loop material laminated to a different type of backing material. The foam backing may be a natural sponge material or polyurethane foam and the like. The foam backing also can be laminated to a different type of backing material. The mesh backings can be made of polymeric or metal open-weave scrims. According to certain embodiments, the backing may include mica.

According to a particular embodiment, the iron oxide filler mixture component 420 may include black iron oxide. According to other embodiments, the iron oxide filler mixture component 420 may include silicone resin. According to yet other embodiments, the iron oxide filler mixture component 420 may include an organic solvent. According to other embodiments, the iron oxide filler mixture component 420 may include any combination of black iron oxide, silicone resin/fluid, with or without organic solvent.

According to a particular embodiment, the iron oxide filler mixture component 420 may consist of black iron oxide. According to other embodiments, the iron oxide filler mixture component 420 may consist of silicone resin. According to yet other embodiments, the iron oxide filler mixture component 420 may consist of an organic solvent. According to other embodiments, the iron oxide filler mixture component 420 may consist of any combination of black iron oxide, silicone resin/fluid, with or without organic solvent.

According to yet other embodiments, the pressure sensitive adhesive 405 may include a particular content of the iron oxide filler mixture component 420. For example, the iron oxide filler mixture component 420 content may be at least about 0.6 wt. % for a total weight of the pressure sensitive adhesive 405, such as, at least about 0.7 wt. % or at least about 0.8 wt. % or at least about 0.9 wt. % or at least about 1.0 wt. % or at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the iron oxide filler mixture component 420 content may be not greater than about 10 wt. % for a total weight of the pressure sensitive adhesive 405, such as, not greater than about 9.0 wt. % or not greater than about 8 wt. % or not greater than about 7 wt. % or not greater than about 6 wt. % not greater than about 5.8 wt. % or not greater than about 5.7 wt. % or not greater than about 5.6 wt. % or not greater than about 5.5 wt. % or not greater than about 5.4 wt. % or not greater than about 5.3 wt. % or not greater than about 5.2 wt. % or even not greater than about 5.1 wt. %. It will be appreciated that the iron oxide filler mixture component 420 content may be any value between, and including, any of the minimum and maximum values noted above. It will be further appreciated that the iron oxide filler mixture component 420 content may be within a range between, and including, any of the minimum and maximum values noted above.

According to still other embodiments, the silicone based pressure sensitive adhesive component 410 may include a methyl silicone adhesive. According to yet other embodiments, the silicone based pressure sensitive adhesive component 410 may include a phenyl silicone adhesive. According to still other embodiments, the silicone based pressure sensitive adhesive component 410 may include a vinyl silicone adhesive. According to yet other embodiments, the silicone based pressure sensitive adhesive component 410 may include any combination of a methyl silicone adhesive, a phenyl silicone adhesive, and a vinyl silicone adhesive.

According to still other embodiments, the silicone based pressure sensitive adhesive component 410 may consist of a methyl silicone adhesive. According to yet other embodiments, the silicone based pressure sensitive adhesive component 410 may consist of a phenyl silicone adhesive. According to still other embodiments, the silicone based pressure sensitive adhesive component 410 may consist of a vinyl silicone adhesive. According to yet other embodiments, the silicone based pressure sensitive adhesive component 410 may consist of any combination of a methyl silicone adhesive, a phenyl silicone adhesive, and a vinyl silicone adhesive.

According to yet other embodiments, the pressure sensitive adhesive 405 may include a particular content of the silicone based pressure sensitive adhesive component 410. For example, the silicone based pressure sensitive adhesive component 410 content may be at least about 45 wt. % for a total weight of the pressure sensitive adhesive 405, such as, at least about 47 wt. % or at least about 50 wt. % or at least about 52 wt. % or at least about 55 wt. % or at least about 57 wt. % or at least about 60 wt. % or at least about 62 wt. % or at least about 65 wt. % or at least about 67 wt. % or at least about 70 wt. % or at least about 72 wt. % or at least about 75 wt. % or at least about 77 wt. % or even at least about 80 wt. %. According to still other embodiments, the silicone based pressure sensitive adhesive component 410 content may be not greater than about 98 wt. % for a total weight of the pressure sensitive adhesive 405, such as, not greater than about 95 wt. % or not greater than about 92 wt. % or not greater than about 90 wt. % or not greater than about 87 wt. % or not greater than about 85 wt. % or even not greater than about 82 wt. %. It will be appreciated that the silicone based pressure sensitive adhesive component 410 content may be any value between, and including, any of the minimum and maximum values noted above. It will be further appreciated that the silicone based pressure sensitive adhesive component 410 content may be within a range between, and including, any of the minimum and maximum values noted above.

According to still other embodiments, the pressure sensitive adhesive 405 may further include a catalyst. According to yet other embodiments, the catalyst may include peroxide. According to still other embodiments, the catalyst may include platinum. According to yet other embodiments, the catalyst may consist of peroxide. According to still other embodiments, the catalyst may consist of platinum.

According to still other embodiments, the pressure sensitive adhesive 405 may include a silicone resin.

According to yet other embodiments, the pressure sensitive adhesive 405 may include an organic solvent. According to still other embodiments, the organic solvent may include toluene. According to still other embodiments, the organic solve may include xylene. According to yet other embodiments, the organic solvent may include ethyl acetate. According to still other embodiments, the organic solvent may consist of toluene. According to still other embodiments, the organic solve may consist of xylene. According to yet other embodiments, the organic solvent may consist of ethyl acetate.

According to still other embodiments, the pressure sensitive adhesive 405 may have a particular peel adhesion as measured at 25° C. according to ASTM D3330. For example, the pressure sensitive adhesive 405 may have a peel adhesion of at least about 610 g/in, such as, at least about 620 g/in or at least about 630 g/in or at least about 640 g/in or at least about 650 g/in or at least about 660 g/in or at least about 670 g/in or at least about 680 g/in or at least about 690 g/in or at least about 700 g/in or at least about 710 g/in or even at least about 720 g/in. According to still other embodiments, the pressure sensitive adhesive 405 may have a peel adhesion of not greater than about 760 g/in, such as, not greater than about 750 g/in or not greater than about 740 g/in. It will be appreciated that the silicone based pressure sensitive adhesive component 410 peel adhesion at 25° C. may be any value between, and including, any of the minimum and maximum values noted above. It will be further appreciated that the silicone based pressure sensitive adhesive component 410 peel adhesion at 25° C. may be within a range between, and including, any of the minimum and maximum values noted above.

According to still other embodiments, the pressure sensitive adhesive 405 may have a particular peel adhesion as measured at 100° C. according to ASTM D3330 (modified such that the heated chamber attached with the thermocouple during the peel test such that the tape and the stainless steel substrates are heated at 100° C. for a 1-minute dwell prior to peeling the tape from the stainless steel). For example, the pressure sensitive adhesive 405 may have a peel adhesion of at least about 280 g/in, such as, at least about 290 g/in or at least about 300 g/in or at least about 310 g/in or at least about 320 g/in or at least about 330 g/in or at least about 340 g/in or at least about 350 g/in or at least about 360 g/in or at least about 370 g/in or at least about 380 g/in or even at least about 390 g/in. According to still other embodiments, the pressure sensitive adhesive 405 may have a peel adhesion of not greater than about 430 g/in, such as, not greater than about 420 g/in or not greater than about 410 g/in. It will be appreciated that the silicone based pressure sensitive adhesive component 410 peel adhesion at 100° C. may be any value between, and including, any of the minimum and maximum values noted above. It will be further appreciated that the silicone based pressure sensitive adhesive component 410 peel adhesion at 100° C. may be within a range between, and including, any of the minimum and maximum values noted above.

According to still other embodiments, the pressure sensitive adhesive 405 may have a particular peel adhesion as measured at 250° C. according to ASTM D3330 (modified such that the heated chamber attached with the thermocouple during the peel test such that the tape and the stainless steel substrates are heated at 250° C. for a 1-minute dwell prior to peeling the tape from the stainless steel). For example, the pressure sensitive adhesive 405 may have a peel adhesion of at least about 50 g/in, such as, at least about 55 g/in or at least about 60 g/in or at least about 65 g/in or at least about 70 g/in or at least about 75 g/in or at least about 80 g/in or even at least about 85 g/in. According to still other embodiments, the pressure sensitive adhesive 405 may have a peel adhesion of not greater than about 100 g/in, such as, not greater than about 95 g/in or not greater than about 90 g/in. It will be appreciated that the silicone based pressure sensitive adhesive component 410 peel adhesion at 250° C. may be any value between, and including, any of the minimum and maximum values noted above. It will be further appreciated that the silicone based pressure sensitive adhesive component 410 peel adhesion at 250° C. may be within a range between, and including, any of the minimum and maximum values noted above.

According to still other embodiments, the pressure sensitive adhesive 405 may have a particular tack as measured using a Texture Analyzer-303C fixture with a 5 mm probe made out of stainless steel, where each sample (5×1 inch, with four replicates) is measured with 2 minutes of contact time, a 0.5 mm/s approach speed, and a 10 mm/s debonding speed. For example, the pressure sensitive adhesive 405 may have a tack of at least about 4.2 N, such as, at least about 4.3 N or at least about 4.4 N or at least about 4.5 N or at least about 4.6 N or at least about 4.7 N or at least about 4.8 N or even at least about 4.9 N. According to still other embodiments, the pressure sensitive adhesive 405 may have a tack of not greater than about 6 N, such as, not greater than about 5.8 N or not greater than about 5.6 N. It will be appreciated that the silicone based pressure sensitive adhesive component 410 tack may be any value between, and including, any of the minimum and maximum values noted above. It will be further appreciated that the silicone based pressure sensitive adhesive component 410 tack may be within a range between, and including, any of the minimum and maximum values noted above.

According to still other embodiments, the pressure sensitive adhesive 405 may have a particular Shear Adhesion Failure Temperature (SAFT) as measured according to ASTM PSTC-17. For example, the pressure sensitive adhesive 405 may have a SAFT of at least about 90° C., such as, at least about 100° C. or at least about 110° C. or at least about 120° C. or at least about 130° C. or at least about 140° C. or at least about 150° C. or even at least about 160° C. According to still other embodiments, the pressure sensitive adhesive 405 may have a tack of not greater than about 200° C., such as, not greater than about 190° C. or not greater than about 180 ° C. It will be appreciated that the silicone based pressure sensitive adhesive component 410 SAFT may be any value between, and including, any of the minimum and maximum values noted above. It will be further appreciated that the silicone based pressure sensitive adhesive component 410 SAFT may be within a range between, and including, any of the minimum and maximum values noted above.

According to yet other embodiments, the pressure sensitive adhesive 405 may have a UL 94 rating of VTM-0 when attached to a backing material. According to still other embodiments, the pressure sensitive adhesive 405 may have a UL 94 rating of V-0. According to still other embodiments, the pressure sensitive adhesive 405 may have a UL 94 rating of both VTM-0 and V-0. It will be appreciated that the appropriate UL 94 rating may depended on the attached backing material, if any, that is used when testing occurs.

According to yet other embodiments, the tape 400 may have a UL 94 rating of VTM-0 when attached to a backing material. According to still other embodiments, the tape 400 may have a UL 94 rating of V-0. According to still other embodiments, tape 400 may have a UL 94 rating of both VTM-0 and V-0. It will be appreciated that the appropriate UL 94 rating may depended on the attached backing material, if any, that is used when testing occurs.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A pressure sensitive adhesive comprising: a silicone based pressure sensitive adhesive component, and an iron oxide filler mixture component at a content of at least about 0.5 wt. % and not greater than about 10.0 wt. % for a total weight of the pressure sensitive adhesive, wherein the pressure sensitive adhesive has a peel adhesion of at least about 600 g/in when measured at 25° C., and wherein the pressure sensitive adhesive has a UL 94 rating of VTM-0, a UL 94 rating of V-0, or a UL 94 rating of both VTM-0 and V-0 when attached to a backing material.

Embodiment 2. The pressure sensitive adhesive of embodiment 1, wherein the iron oxide filler mixture component comprises black iron oxide, silicone resin/fluid, with or without organic solvent, or any combinations thereof.

Embodiment 3. The pressure sensitive adhesive of embodiment 1, wherein the iron oxide filler mixture component consists of black iron oxide, silicone resin/fluid, with or without organic solvent, or any combinations thereof.

Embodiment 4. The pressure sensitive adhesive of embodiment 1, wherein the pressure sensitive adhesive comprises an iron oxide filler content of at least about 0.6 wt. % for a total weight of the pressure sensitive adhesive.

Embodiment 5. The pressure sensitive adhesive of embodiment 1, wherein the pressure sensitive adhesive comprises an iron oxide filler mixture component content of not greater than about 10 wt. % for a total weight of the pressure sensitive adhesive.

Embodiment 6. The pressure sensitive adhesive of embodiment 1, wherein the pressure sensitive adhesive comprises black iron oxide.

Embodiment 7. The pressure sensitive adhesive of embodiment 1, wherein the pressure sensitive adhesive comprises silicone adhesive.

Embodiment 8. The pressure sensitive adhesive of embodiment 7, wherein the silicone adhesive comprises a methyl silicone adhesive, a phenyl silicone adhesive, a vinyl silicone adhesive, or any combination thereof.

Embodiment 9. The pressure sensitive adhesive of embodiment 1, wherein the pressure sensitive adhesive comprises a catalyst.

Embodiment 10. The pressure sensitive adhesive of embodiment 9, wherein the catalyst comprises peroxide, or platinum.

Embodiment 11. The pressure sensitive adhesive of embodiment 1, wherein the pressure sensitive adhesive comprises a silicone resin.

Embodiment 12. The pressure sensitive adhesive of embodiment 1, wherein the pressure sensitive adhesive comprises an organic solvent.

Embodiment 13. The pressure sensitive adhesive of embodiment 12, wherein the organic solvent comprises toluene, xylene, ethyl acetate.

Embodiment 14. The pressure sensitive adhesive of embodiment 1, wherein the pressure sensitive adhesive consists of black iron oxide.

Embodiment 15. The pressure sensitive adhesive of embodiment 1, wherein the pressure sensitive adhesive consists of silicone adhesive.

Embodiment 16. The pressure sensitive adhesive of embodiment 15, wherein the silicone adhesive consists of a methyl silicone adhesive, a phenyl silicone adhesive, a vinyl silicone adhesive, or any combination thereof.

Embodiment 17. The pressure sensitive adhesive of embodiment 1, wherein the pressure sensitive adhesive consists of a catalyst.

Embodiment 18. The pressure sensitive adhesive of embodiment 17, wherein the catalyst consists of peroxide, or platinum.

Embodiment 19. The pressure sensitive adhesive of embodiment 1, wherein the pressure sensitive adhesive consists of a silicone resin.

Embodiment 20. The pressure sensitive adhesive of embodiment 1, wherein the pressure sensitive adhesive consists of an organic solvent.

Embodiment 21. The pressure sensitive adhesive of embodiment 20, wherein the organic solvent consists of toluene, xylene, ethyl acetate.

Embodiment 22. The pressure sensitive adhesive of embodiment 1, wherein the pressure sensitive adhesive comprises a silicone based pressure sensitive adhesive component content of at least about 45 wt. % for a total weight of the pressure sensitive adhesive.

Embodiment 23. The pressure sensitive adhesive of embodiment 1, wherein the pressure sensitive adhesive comprises a silicone based pressure sensitive adhesive component content of not greater than about 98 wt. % for a total weight of the pressure sensitive adhesive.

Embodiment 24. The pressure sensitive adhesive of embodiment 1, wherein the pressure sensitive adhesive has a peel adhesion of at least about 610 g/in as measured at 25° C.

Embodiment 25. The pressure sensitive adhesive of embodiment 1, wherein the pressure sensitive adhesive has a peel adhesion of not greater than about 760 g/in as measured at 25° C.

Embodiment 26. The pressure sensitive adhesive of embodiment 1, wherein the pressure sensitive adhesive has a peel adhesion of at least about 280 g/in as measured at 100° C.

Embodiment 27. The pressure sensitive adhesive of embodiment 1, wherein the pressure sensitive adhesive has a peel adhesion of not greater than about 430 g/in as measured at 100° C.

Embodiment 28. The pressure sensitive adhesive of embodiment 1, wherein the pressure sensitive adhesive has a peel adhesion of at least about 50 g/in as measured at 250° C.

Embodiment 29. The pressure sensitive adhesive of embodiment 1, wherein the pressure sensitive adhesive has a peel adhesion of not greater than about 100 g/in as measured at 250° C.

Embodiment 30. The pressure sensitive adhesive of embodiment 1, wherein the pressure sensitive adhesive has a Tack of at least about 4.2 N.

Embodiment 31. The pressure sensitive adhesive of embodiment 1, wherein the pressure sensitive adhesive has a Tack of not greater than about 6 N.

Embodiment 32. The pressure sensitive adhesive of embodiment 1, wherein the pressure sensitive adhesive has a SAFT of at least about 90° C.

Embodiment 33. The pressure sensitive adhesive of embodiment 1, wherein the pressure sensitive adhesive has a SAFT of not greater than about 200° C.

Embodiment 34. The pressure sensitive adhesive of embodiment 1, wherein the pressure sensitive adhesive has a UL 94 rating of V-0.

Embodiment 35. A tape comprising a backing layer and a layer of pressure sensitive adhesive, wherein the pressure sensitive adhesive comprises: a silicone based pressure sensitive adhesive component, and an iron oxide filler at a content of at least about 0.5 wt. % and not greater than about 10.0 wt. % for a total weight of the pressure sensitive adhesive, wherein the pressure sensitive adhesive has a peel adhesion of at least about 600 g/in when measured at 25° C., and wherein the pressure sensitive adhesive has a UL 94 rating of VTM-0, a UL 94 rating of V-0, or a UL 94 rating of both VTM-0 and V-0 when attached to a backing material.

Embodiment 36. The tape of embodiment 35, wherein the iron oxide filler mixture component comprises black iron oxide, silicone resin/fluid, with or without organic solvent or any combinations thereof or any combinations thereof.

Embodiment 37. The tape of embodiment 35, wherein the iron oxide filler mixture component consists of black iron oxide, silicone resin/fluid, with or without organic solvent or any combinations thereof.

Embodiment 38. The tape of embodiment 35, wherein the pressure sensitive adhesive comprises an iron oxide filler mixture component content of at least about 0.6 wt. % for a total weight of the pressure sensitive adhesive.

Embodiment 39. The tape of embodiment 35, wherein the pressure sensitive adhesive comprises an iron oxide filler content of not greater than about 10 wt. % for a total weight of the pressure sensitive adhesive.

Embodiment 40. The tape of embodiment 35, wherein the pressure sensitive adhesive comprises silicone adhesive.

Embodiment 41. The tape of embodiment 40, wherein the silicone adhesive comprises a methyl silicone adhesive, a phenyl silicone adhesive, a vinyl silicone adhesive, or any combination thereof.

Embodiment 42. The tape of embodiment 35, wherein the pressure sensitive adhesive comprises a catalyst.

Embodiment 43. The tape of embodiment 42, wherein the catalyst comprises peroxide, or platinum.

Embodiment 44. The tape of embodiment 35, wherein the pressure sensitive adhesive comprises a silicone resin.

Embodiment 45. The tape of embodiment 35, wherein the pressure sensitive adhesive comprises an organic solvent.

Embodiment 46. The tape of embodiment 45, wherein the organic solvent comprises toluene, xylene, ethyl acetate.

Embodiment 47. The tape of embodiment 35, wherein the pressure sensitive adhesive consists of black iron oxide.

Embodiment 48. The tape of embodiment 35, wherein the pressure sensitive adhesive consists of silicone adhesive.

Embodiment 49. The tape of embodiment 48, wherein the silicone adhesive consists of a methyl silicone adhesive, a phenyl silicone adhesive, a vinyl silicone adhesive, or any combination thereof.

Embodiment 50. The tape of embodiment 35, wherein the pressure sensitive adhesive consists of a catalyst.

Embodiment 51. The tape of embodiment 50, wherein the catalyst consists of peroxide, or platinum.

Embodiment 52. The tape of embodiment 35, wherein the pressure sensitive adhesive consists of a silicone resin.

Embodiment 53. The tape of embodiment 35, wherein the pressure sensitive adhesive consists of an organic solvent.

Embodiment 54. The tape of embodiment 53, wherein the organic solvent consists of toluene, xylene, ethyl acetate.

Embodiment 55. The tape of embodiment 35, wherein the pressure sensitive adhesive comprises a silicone based pressure sensitive adhesive component content of at least about 45 wt. % for a total weight of the pressure sensitive adhesive.

Embodiment 56. The tape of embodiment 35, wherein the pressure sensitive adhesive comprises a silicone based pressure sensitive adhesive component content of not greater than about 98 wt. % for a total weight of the pressure sensitive adhesive.

Embodiment 57. The tape of embodiment 35, wherein the pressure sensitive adhesive has a peel adhesion of at least about 610 g/in as measured at 25° C.

Embodiment 58. The tape of embodiment 35, wherein the pressure sensitive adhesive has a peel adhesion of not greater than about 760 g/in as measured at 25° C.

Embodiment 59. The tape of embodiment 35, wherein the pressure sensitive adhesive has a peel adhesion of at least about 280 g/in as measured at 100° C.

Embodiment 60. The tape of embodiment 35, wherein the pressure sensitive adhesive has a peel adhesion of not greater than about 430 g/in as measured at 100° C.

Embodiment 61. The tape of embodiment 35, wherein the pressure sensitive adhesive has a peel adhesion of at least about 50 g/in as measured at 250° C.

Embodiment 62. The tape of embodiment 35, wherein the pressure sensitive adhesive has a peel adhesion of not greater than about 100 g/in as measured at 250° C.

Embodiment 63. The tape of embodiment 35, wherein the pressure sensitive adhesive has a Tack of at least about 4.2 N.

Embodiment 64. The tape of embodiment 35, wherein the pressure sensitive adhesive has a Tack of not greater than about 6 N.

Embodiment 65. The tape of embodiment 35, wherein the pressure sensitive adhesive has a SAFT of at least about 90° C.

Embodiment 66. The tape of embodiment 35, wherein the pressure sensitive adhesive has a SAFT of not greater than about 200° C.

Embodiment 67. The tape of embodiment 35, wherein the pressure sensitive adhesive has a UL 94 rating of V-0.

Embodiment 68. The tape of embodiment 35, wherein the backing comprises cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof.

Embodiment 69. A method of forming a pressure sensitive adhesive, wherein the method comprises: providing a forming mixture of a silicone based pressure sensitive adhesive precursor component and an iron oxide filler precursor mixture component, and forming the forming mixture into a pressure sensitive adhesive, wherein the pressure sensitive adhesive comprises: a silicone based pressure sensitive adhesive component, and an iron oxide filler mixture at a content of at least about 0.5 wt. % and not greater than about 3.0 wt. % for a total weight of the pressure sensitive adhesive, wherein the pressure sensitive adhesive has a peel adhesion of at least about 600 g/in when measured at 25° C., and wherein the pressure sensitive adhesive has a UL 94 rating of VTM-0, a UL 94 rating of V-0, or a UL 94 rating of both VTM-0 and V-0 when attached to a backing material.

Embodiment 70. The method of embodiment 69, wherein the iron oxide filler mixture comprises black iron oxide, silicone resin/fluid, with or without organic solvent or any combinations thereof.

Embodiment 71. The method of embodiment 69, wherein the iron oxide filler mixture consists of black iron oxide, silicone resin/fluid, with or without organic solvent, or any combinations thereof.

Embodiment 72. The method of embodiment 69, wherein the pressure sensitive adhesive comprises an iron oxide filler mixture content of at least about 0.6 wt. % for a total weight of the pressure sensitive adhesive.

Embodiment 73. The method of embodiment 69, wherein the pressure sensitive adhesive comprises an iron oxide filler mixture content of not greater than about 10 wt. % for a total weight of the pressure sensitive adhesive.

Embodiment 74. The method of embodiment 69, wherein the pressure sensitive adhesive comprises black iron oxide.

Embodiment 75. The method of embodiment 69, wherein the pressure sensitive adhesive comprises silicone adhesive.

Embodiment 76. The method of embodiment 75, wherein the silicone adhesive comprises a methyl silicone adhesive, a phenyl silicone adhesive, a vinyl silicone adhesive, or any combination thereof.

Embodiment 77. The method of embodiment 69, wherein the pressure sensitive adhesive comprises a catalyst.

Embodiment 78. The method of embodiment 77, wherein the catalyst comprises peroxide, or platinum.

Embodiment 79. The method of embodiment 69, wherein the pressure sensitive adhesive comprises a silicone resin.

Embodiment 80. The method of embodiment 69, wherein the pressure sensitive adhesive comprises an organic solvent.

Embodiment 81. The method of embodiment 80, wherein the organic solvent comprises toluene, xylene, ethyl acetate.

Embodiment 82. The method of embodiment 69, wherein the pressure sensitive adhesive consists of black iron oxide.

Embodiment 83. The method of embodiment 69, wherein the pressure sensitive adhesive consists of silicone adhesive.

Embodiment 84. The method of embodiment 83, wherein the silicone adhesive consists of a methyl silicone adhesive, a phenyl silicone adhesive, a vinyl silicone adhesive, or any combination thereof.

Embodiment 85. The method of embodiment 69, wherein the pressure sensitive adhesive consists of a catalyst.

Embodiment 86. The method of embodiment 85, wherein the catalyst consists of peroxide, or platinum.

Embodiment 87. The method of embodiment 69, wherein the pressure sensitive adhesive consists of a silicone resin.

Embodiment 88. The method of embodiment 69, wherein the pressure sensitive adhesive consists of an organic solvent.

Embodiment 89. The method of embodiment 88, wherein the organic solvent consists of toluene, xylene, ethyl acetate.

Embodiment 90. The method of embodiment 69, wherein the pressure sensitive adhesive comprises a silicone based pressure sensitive adhesive component content of at least about 45 wt. % for a total weight of the pressure sensitive adhesive.

Embodiment 91. The method of embodiment 69, wherein the pressure sensitive adhesive comprises a silicone based pressure sensitive adhesive component content of not greater than about 98 wt. % for a total weight of the pressure sensitive adhesive.

Embodiment 92. The method of embodiment 69, wherein the pressure sensitive adhesive has a peel adhesion of at least about 610 g/in as measured at 25° C.

Embodiment 93. The method of embodiment 69, wherein the pressure sensitive adhesive has a peel adhesion of not greater than about 760 g/in as measured at 25° C.

Embodiment 94. The method of embodiment 69, wherein the pressure sensitive adhesive has a peel adhesion of at least about 280 g/in as measured at 100° C.

Embodiment 95. The method of embodiment 69, wherein the pressure sensitive adhesive has a peel adhesion of not greater than about 430 g/in as measured at 100° C.

Embodiment 96. The pressure sensitive adhesive of embodiment 1, wherein the pressure sensitive adhesive has a peel adhesion of at least about 50 g/in as measured at 250° C.

Embodiment 97. The method of embodiment 69, wherein the pressure sensitive adhesive has a peel adhesion of not greater than about 100 g/in as measured at 250° C.

Embodiment 98. The method of embodiment 69, wherein the pressure sensitive adhesive has a Tack of at least about 4.2 N.

Embodiment 99. The method of embodiment 69, wherein the pressure sensitive adhesive has a Tack of not greater than about 6 N.

Embodiment 100. The method of embodiment 69, wherein the pressure sensitive adhesive has a SAFT of at least about 90° C.

Embodiment 101. The method of embodiment 69, wherein the pressure sensitive adhesive has a SAFT of not greater than about 200° C.

Embodiment 102. The method of embodiment 69, wherein the pressure sensitive adhesive has a UL 94 rating of V-0.

### EXAMPLES

The concepts described herein will be further described in the following Examples, which do not limit the scope of the invention described in the claims.

### Example 1

Sample pressure sensitive adhesive S1-S6 were formed according to certain embodiments described herein and applied as a 1.5 mil thick layer to a polyimide backing material. Each sample pressure sensitive adhesive S1-S6 includes a silicone based pressure sensitive adhesive component and a particular content of iron oxide filler. A comparative sample pressure sensitive adhesive CS1 was formed using the same silicone based pressure sensitive adhesive component and no iron oxide filler and applied as a 1.5 mil thick layer to a polyimide backing material. Composition details for sample pressure sensitive adhesive layers S1-S6 and comparative sample pressure sensitive adhesive layer CS1 are summarized in Table 1 below.

TABLE 1
Sample Pressure Sensitive Adhesives

| | Iron Oxide Content (wt. % for total |
|---|---|
| Sample No. | weight of the PSA) |
| S1 | 1.0 |
| S2 | 2.0 |
| S3 | 4.0 |
| S4 | 5.0 |
| S5 | 6.0 |
| CS1 | 0.0 |

Performance properties of each sample pressure sensitive adhesive S1-S6 and comparative sample CS1 are summarized in Table 2 below. The summarized performance properties include peel adhesion measured at 25° C., 100° C., and 250° C. according to ASTM D3330, tack, and UL94 flammability test results.

TABLE 2
Performance Properties

| | Peel | Peel | Peel | | | |
|---|---|---|---|---|---|---|
| | Adhesion | Adhesion | Adhesion | | VTM-0 | V-0 |
| Sample | (g/in) at | (g/in) at | (g/in) at | Tack | (Pass/ | (Pass/ |
| No. | 25° C. | 100° C. | 250° C. | (N) | Fail) | Fail) |
| S1 | 750 | 425 | 120 | 4.2 | PASS | PASS |
| S2 | 760 | 320 | 120 | 4.3 | PASS | PASS |
| S3 | 735 | 290 | 120 | 4.4 | PASS | PASS |
| S4 | 745 | 350 | 124 | 5.2 | PASS | PASS |
| S5 | 625 | 300 | 122 | 5.1 | PASS | PASS |
| CS1 | 850 | 450 | 125 | 4.1 | N/A | N/A |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A pressure sensitive adhesive comprising:
a silicone based pressure sensitive adhesive component, and
an iron oxide filler mixture component at a content of at least about 0.5 wt. % and not greater than about 10.0 wt. % for a total weight of the pressure sensitive adhesive,
wherein the pressure sensitive adhesive has a peel adhesion of at least about 600 g/in when measured at 25° C., and
wherein the pressure sensitive adhesive has a UL 94 rating of VTM-0, a UL 94 rating of V-0, or a UL 94 rating of both VTM-0 and V-0 when attached to a backing material.

2. The pressure sensitive adhesive of claim 1, wherein the iron oxide filler mixture component comprises black iron oxide, silicone resin/fluid, with or without organic solvent, or any combinations thereof.

3. The pressure sensitive adhesive of claim 1, wherein the pressure sensitive adhesive comprises an iron oxide filler content of at least about 0.6 wt. % for a total weight of the pressure sensitive adhesive.

4. The pressure sensitive adhesive of claim 1, wherein the pressure sensitive adhesive comprises an iron oxide filler mixture component content of not greater than about 10 wt. % for a total weight of the pressure sensitive adhesive.

5. The pressure sensitive adhesive of claim 1, wherein the pressure sensitive adhesive comprises black iron oxide.

6. The pressure sensitive adhesive of claim 1, wherein the pressure sensitive adhesive comprises silicone adhesive.

7. The pressure sensitive adhesive of claim 6, wherein the silicone adhesive comprises a methyl silicone adhesive, a phenyl silicone adhesive, a vinyl silicone adhesive, or any combination thereof.

8. The pressure sensitive adhesive of claim 1, wherein the pressure sensitive adhesive comprises a catalyst.

9. The pressure sensitive adhesive of claim 8, wherein the catalyst comprises peroxide, or platinum.

10. The pressure sensitive adhesive of claim 1, wherein the pressure sensitive adhesive comprises a silicone resin.

11. The pressure sensitive adhesive of claim 1, wherein the pressure sensitive adhesive comprises an organic solvent.

12. The pressure sensitive adhesive of claim 11, wherein the organic solvent comprises toluene, xylene, ethyl acetate.

13. The pressure sensitive adhesive of claim 1, wherein the pressure sensitive adhesive has a peel adhesion of at least about 610 g/in as measured at 25° C.

14. The pressure sensitive adhesive of claim 1, wherein the pressure sensitive adhesive has a peel adhesion of at least about 280 g/in as measured at 100° C.

15. The pressure sensitive adhesive of claim 1, wherein the pressure sensitive adhesive has a peel adhesion of at least about 50 g/in as measured at 250° C.

16. The pressure sensitive adhesive of claim 1, wherein the pressure sensitive adhesive has a Tack of at least about 4.2 N.

17. The pressure sensitive adhesive of claim 1, wherein the pressure sensitive adhesive has a UL 94 rating of V-0.

18. A tape comprising a backing layer and a layer of pressure sensitive adhesive, wherein the pressure sensitive adhesive comprises:
a silicone based pressure sensitive adhesive component, and
an iron oxide filler at a content of at least about 0.5 wt. % and not greater than about 10.0 wt. % for a total weight of the pressure sensitive adhesive,
wherein the pressure sensitive adhesive has a peel adhesion of at least about 600 g/in when measured at 25° C., and
wherein the pressure sensitive adhesive has a UL 94 rating of VTM-0, a UL 94 rating of V-0, or a UL 94 rating of both VTM-0 and V-0 when attached to a backing material.

19. The tape of claim 18, wherein the iron oxide filler mixture component comprises black iron oxide, silicone resin/fluid, with or without organic solvent, or any combinations thereof.

20. A method of forming a pressure sensitive adhesive, wherein the method comprises:
providing a forming mixture of a silicone based pressure sensitive adhesive precursor component and an iron oxide filler precursor mixture component, and
forming the forming mixture into a pressure sensitive adhesive, wherein the pressure sensitive adhesive comprises:
a silicone based pressure sensitive adhesive component, and
an iron oxide filler mixture at a content of at least about 0.5 wt. % and not greater than about 3.0 wt. % for a total weight of the pressure sensitive adhesive,
wherein the pressure sensitive adhesive has a peel adhesion of at least about 600 g/in when measured at 25° C., and
wherein the pressure sensitive adhesive has a UL 94 rating of VTM-0, a UL 94 rating of V-0, or a UL 94 rating of both VTM-0 and V-0 when attached to a backing material.
